(19) United States
(12) Patent Application Publication
(10) Pub. No.: US 2014/0033103 A1
(43) Pub. Date: Jan. 30, 2014

(54) SYSTEM, METHOD, AND SOFTWARE FOR PATIENT MONITORING

(71) Applicants: Robert Boyer, Longmont, CO (US); William A. Jordan, Westminster, CO (US)

(72) Inventors: Robert Boyer, Longmont, CO (US); William A. Jordan, Westminster, CO (US)

(73) Assignee: NELLCOR PURITAN BENNETT LLC, Boulder, CO (US)

(21) Appl. No.: 13/559,204

(22) Filed: Jul. 26, 2012

(51) Int. Cl. G06F 3/048

(52) U.S. Cl. 715/771

(57) ABSTRACT

A method for patient monitoring includes receiving first patient parameters from at least one machine. The method further includes transforming the first patient parameters into display parameters comprising at least one of a patient identifier, a patient status, and an alarm condition. Transforming is performed such that a first set of the display parameters is operable to be displayed on a screen, a second set of the display parameters is operable to be displayed on the screen in response to a rotation of the screen in a first direction, and a third set of the display parameters is operable to be displayed on the screen in response to a rotation of the screen in a second direction. The second set of the display parameters is not identical to the third set of the display parameters. The method further includes updating the display parameters in response to receiving second patient parameters.

### TECHNICAL FIELD

The present disclosure relates generally to patient monitoring, and more particularly to a system, method, and software for patient monitoring.

### BACKGROUND

When monitoring a patient, a medical device may collect and display information about that patient. The medical device may collect information through one or more of a variety of ways, such as a patient interface that measures a physiological condition, or a user interface that collects information input by a user. One may rely on this information to assess and treat the health of the patient.

### SUMMARY

According to the present disclosure, disadvantages and problems associated with previous techniques for monitoring patients may be reduced or eliminated.

In certain embodiments, a method for patient monitoring includes receiving first patient parameters from at least one machine. The method further includes transforming the first patient parameters into display parameters comprising at least one of a patient identifier, a patient status, and an alarm condition. Transforming is performed such that a first set of the display parameters is operable to be displayed on a device, a second set of the display parameters is operable to be displayed on the device in response to a rotation of the device in a first direction, and a third set of the display parameters is operable to be displayed on the device in response to a rotation of the device in a second direction. The second set of the display parameters is not identical to the third set of the display parameters. The method further includes updating the display parameters in response to receiving second patient parameters.

Certain embodiments of the present disclosure may provide one or more technical advantages that relate to device ergonomics. For example, a nurse responsible for monitoring patients may access and manipulate the display of information regarding a patient on a mobile device using a single hand. This technical advantage may be particularly useful in circumstances where the nurse is working with several instruments and may be holding additional objects.

Certain embodiments of the present disclosure may provide one or more technical advantages that relate to improved methods of patient data delivery. For example, in certain embodiments, a staff member may access patient information remotely, perhaps even from home, not just those areas of a room or hospital that are hard-wired to a patient-monitoring machine. As another example, a doctor may identify a potential emergency based on information viewed on a mobile device from home. As another example, multiple hospitals or multiple teams within a single hospital may share data about a patient for coordinating treatment. As another example, emergency response teams may transmit data regarding a patient to a hospital while en route to the hospital. These example technical advantages may improve the quality of patient treatment and lower the overall cost of medical care.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system for patient monitoring, according to certain embodiments of the present disclosure;

FIG. 2A illustrates an example remote device of the system for patient monitoring in FIG. 1, according to certain embodiments of the present disclosure;

FIG. 2B illustrates one embodiment of remote device configured to provide certain views of display parameters, according to certain embodiments of the present disclosure;

FIG. 3 illustrates an example remote device of the system for patient monitoring in FIG. 1 in a first position, according to certain embodiments of the present disclosure;

FIG. 4 illustrates an example remote device of the system for patient monitoring in FIG. 1 in a second position, according to certain embodiments of the present disclosure;

FIG. 5 illustrates an example remote device of the system for patient monitoring in FIG. 1 in a third position, according to certain embodiments of the present disclosure; and

FIG. 6 illustrates an example method for patient monitoring, according to certain embodiments of the present disclosure.

### DETAILED DESCRIPTION

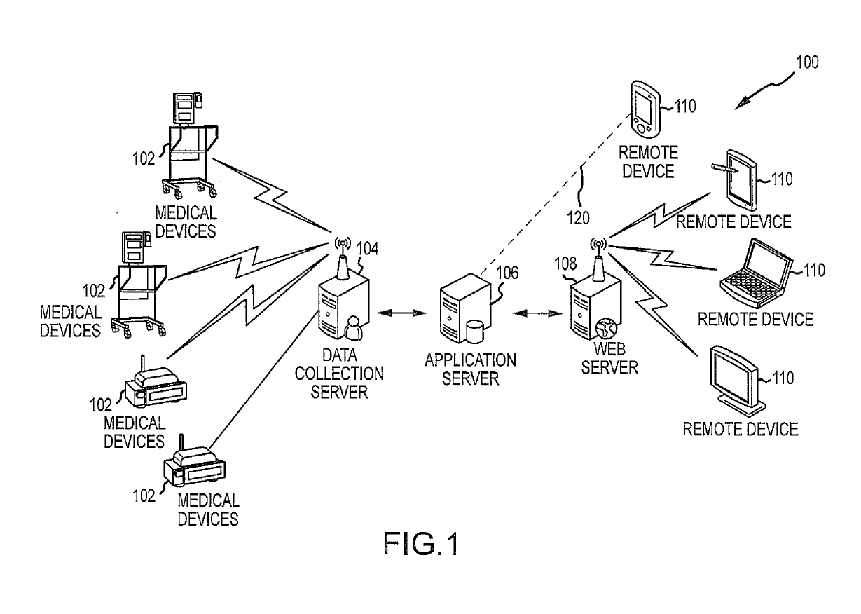

FIG. 1 illustrates an example system 100 for patient monitoring, according to certain embodiments of the present disclosure. System 100 includes one or more medical devices 102, a data collection server 104, an application server 106, a web server 108, and one or more remote devices 110. Although this particular implementation of system 100 is illustrated and primarily described, the present disclosure contemplates any suitable implementation of system 100 according to particular needs.

According to one embodiment, system 100 is operable to monitor medical devices 102 and transform patient parameters into display parameters. In certain embodiments, medical devices 102 generate patient parameters or store patient parameters input by a user. Patient parameters may refer to any patient identifiers, medical history, clinician notes, alarm thresholds, alarm events, device settings, measurements of values indicating physiological conditions such as oxygen saturation levels, pulse rates, heart rates, other vital signs, and any other output data from medical devices 102. Each medical device 102 may be connected to data collection server 104, which stores the patient parameters in a database. Application server 106 retrieves the patient parameters from the database and processes the patient parameters into display parameters for web server 108. Remote devices 110 request and receive the display parameters and display the display parameters through a browser and/or a native application on remote devices 110, thereby enabling clinicians using the remote devices 110 to view the display parameters in remote locations. As described in more detail below, the display parameters are operable such that one set of desired display parameters is accessible by holding remote device 110 in a first position, another set of desired display parameters is accessible by turning remote device 110 in a first direction, perhaps clockwise, and a third set of display parameters is accessible by turning remote device 110 in another direction, perhaps counter-clockwise, from the first position.

System 100 may include one or more medical devices 102. Medical devices 102 may be any devices that are used for tracking or treating patients. For example, medical devices 102 may include a ventilator connected to a patient to deliver respiration therapy. As another example, medical devices 102 may include a pulse oximeter that monitors the oxygen saturation of a patient's blood. As another example, medical devices 102 may include a device for tracking a patient without monitoring physiological conditions. In short, medical devices 102 may include any suitable combination of software, firmware, and hardware used to support any medical function. It should be noted that any suitable number of medical devices 102 may be included in system 100. In addition, there may be multiple groups of medical devices 102 in system 100.

According to one embodiment, in addition to performing a medical function, medical devices 102 may generate output data tracked by medical devices 102. For example, the ventilator may generate entries indicating the average volume of air expelled in each breath. The ventilator may generate entries identifying the parameter settings used by the ventilator and whether any alarms have been triggered. The ventilator may store the generated entries in local memory and output the entries. In some embodiments, medical devices may generate output data that is related to tracking patient identifications or locations, without necessarily generating data related to a physiological condition. In certain embodiments, medical devices 102 may output data in response to a data request. In certain other embodiments, medical devices 102 may constantly stream output data. In these embodiments, medical devices 102 may require an initial start signal or request signal prior to streaming data.

Medical devices 102 may be communicatively coupled to data collection server 104 via a network, according to one embodiment. The network facilitates wireless or wireline communication. The network may communicate, for example, IP packets, Frame Relay frames, Asynchronous Transfer Mode (ATM) cells, TDMA, CDMA, voice, video, data, and other suitable information between network addresses. The network may include one or more personal area networks (PANs), local area networks (LANs), radio access networks (RANs), metropolitan area networks (MANs), wide area networks (WANs), all or a portion of the global computer network known as the Internet, and/or any other communication system or systems at one or more locations. In certain embodiments, medical devices 102 may be communicatively coupled to other suitable devices including data collection server 104, application server 106, web server 108, and remote devices 110. In certain embodiments, data collection server 104 may be connected to other similar data collection servers in a particular format, such as a daisy-chain connection format.

System 100 may include one or more data collection servers 104, referred to primarily in the singular throughout this disclosure. Data collection server 104 may include one or more electronic computing devices operable to receive, transmit, process, and store data associated with system 100. For example, data collection server 104 may include one or more general-purpose PCs, Macintoshes, workstations, mainframes, server computers, one or more server pools, or any other suitable hardware. In addition, data collection server 104 may use any suitable operating system such as Windows, Apple, Linux, UNIX or any future operating system. In certain embodiments, data collection server 104 includes a web server. In short, data collection server 104 may include any suitable combination of software, firmware, and hardware. Although a single data collection server 104 is illustrated, the present disclosure contemplates system 100 including any suitable number of data collection servers 104. Moreover, although referred to as a data collection server, the present disclosure contemplates data collection server 104 comprising any suitable type of processing device or devices.

According to one embodiment, data collection server 104 receives patient parameters from medical devices 102. For example, data collection server 104 may request patient parameters from medical device 102 and receive patient parameters from medical device 102 in response to the request. As another example, data collection server 104 may receive streamed output data from a medical device 102. As another example, data collection server 104 may be configured to periodically request new data from medical device 102. Data collection server 104 may map the received patient parameters to match internal fields in the database and then transmit the data to a database, according to one embodiment. The stored data may be accessed by application server 106.

System 100 may include one or more application servers 106, referred to primarily in the singular throughout this disclosure. Application server 106 may include one or more electronic computing devices operable to receive, transmit, process, and store data associated with system 100. For example, application server 106 may include one or more general-purpose PCs, Macintoshes, workstations, mainframes, server computers, one or more server pools, or any other suitable hardware. In addition, application server 106 may use any suitable operating system such as Windows, Apple, Linux, UNIX or any future operating system. In short, application server 106 may include any suitable combination of software, firmware, and hardware. Although a single application server 106 is illustrated, the present disclosure contemplates system 100 including any suitable number of application servers 106. Moreover, although referred to as an application server, the present disclosure contemplates application server 106 comprising any suitable type of processing device or devices.

According to one embodiment, application server 106 creates a data service that runs on a conventional web services platform for transmitting data to web server 108. Application server 106 may include a database server in certain embodiments. According to one embodiment, application server 106 may include a logical system that may execute an algorithm, such as a clinical application using patient parameters including first patient parameters. For example, application server 106 may create display parameters using first patient parameters, and those display parameters are transmitted to web server 108. Application server 106 may maintain an activity log that logs data requests from remote devices 110 to track certain activities performed at remote devices 110. Therefore, if a clinician selects a particular patient representation to zoom in and view ventilator data specific to that patient, that selection may trigger a data request that is logged by application server 106. For example, when creating the display parameters, application server 106 may compare the current parameter settings of the ventilator, as indicated by entries in the patient parameter set, to prior parameter settings. If any changes are detected, application server 106 may flag those changes for presentation to users on remote devices 110. Specifically, application server 106 may create data causing the depiction of the changed display parameters on remote devices 110 to change color in response to receiving second patient parameters. Second patient parameters may include new parameters, for example, parameters associated with an additional machine or patient being monitored. Second patient parameters may further include changed patient parameters, such as a change in a temperature of a patient. Application server 106 may create additional display parameters that cause a pop-up window to appear on the mobile device when any of the changed display parameters are selected. The pop-up window may list all of the changed display parameters and provide a single button through which a user may indicate that that the changed display parameters have been viewed. If that button is activated, the mobile device may transmit a message to application server 106 by way of web server 108 and application server 106 may then unflag those display parameters, such that the depiction of those patient parameters on remote device 110 may return to the original color. In certain embodiments, application server 106 may transmit data directly to remote devices 110.

System 100 may include one or more web servers 108, referred to primarily in the singular throughout this disclosure. Web server 108 may include one or more electronic computing devices operable to receive, transmit, process, and store data associated with system 100. For example, web server 108 may include one or more general-purpose PCs, Macintoshes, workstations, mainframes, server computers, one or more server pools, or any other suitable hardware. In addition, web server 108 may use any suitable operating system such as Windows, Apple, Linux, UNIX or any future operating system. In short, web server 108 may include any suitable combination of software, firmware, and hardware. Although a single web server 108 is illustrated, the present disclosure contemplates system 100 including any suitable number of web servers 108. Moreover, although referred to as a web server, the present disclosure contemplates web server 108 comprising any suitable type of processing device or devices.

According to one embodiment, web server 108 creates a data service that runs on a conventional web services platform for receiving data from application server 106 and transmitting data to remote devices 110. For example, web server 108 may receive display parameters from application server 106 and transmit, upon request in certain embodiments, to remote devices 110.

System 100 may include one or more remote devices 110. Remote devices 110 may be any device that provides output to and can receive input from a user, such as a clinician. Each remote device 110 may include one or more computer systems at one or more locations. In certain embodiments, output at remote devices may include vibrations, display views including pop-up messages, sound, or any combination desired. In some embodiments, remote devices 110 may connect to application server 106 through a direct socket connection, as indicated by reference number 120 in FIG. 1. Each computer system may include any appropriate input devices (such as a keypad, touch screen, mouse, or other device that can accept input), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user. Each computer system may include a personal computer, workstation, network computer, kiosk, wireless data port, personal data assistant (FDA), one or more processors within these or other devices, or any other suitable processing device.

According to one embodiment, remote devices 110 display one or more web pages hosted by application server 106 and/or web server 108 with display parameters related to the patient parameters from medical devices 102. For example, a clinician may activate a browser on remote device 110 and navigate to a web page hosted by web server 108. The browser may render the web page, which includes display parameters generated by application server 106. The web page may provide a summary of all medical devices 102 under a clinician's responsibility. In addition, the web page may enable a detailed view that displays specific device data, therapy parameter data, and alarm status data.

Although FIG. 1 depicts separate devices for data collection server 104, application server 106, and web server 108, it will be readily apparent that the functions of these devices may be combined into a single device that receives patient parameters from medical devices 102 and transforms the patient parameters into display parameters. It will also be understood that this single device may alternatively transmit the display parameters to remote device 110.

It will also be understood that the functions may be allocated differently than shown, with application server 106 additionally performing the functions of web server 108 or the functions of data collection server 104. In another embodiment, a single device may receive patient parameters, transform those patient parameters into display parameters, and display the display parameters on a screen.

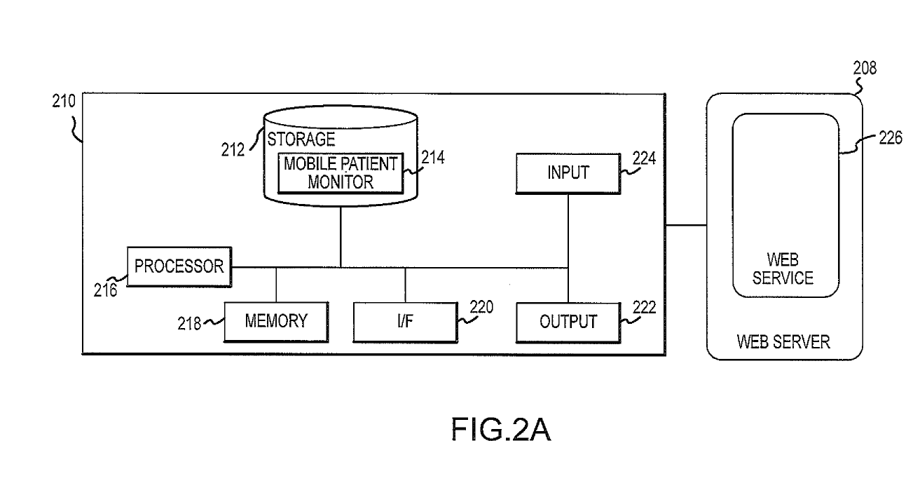

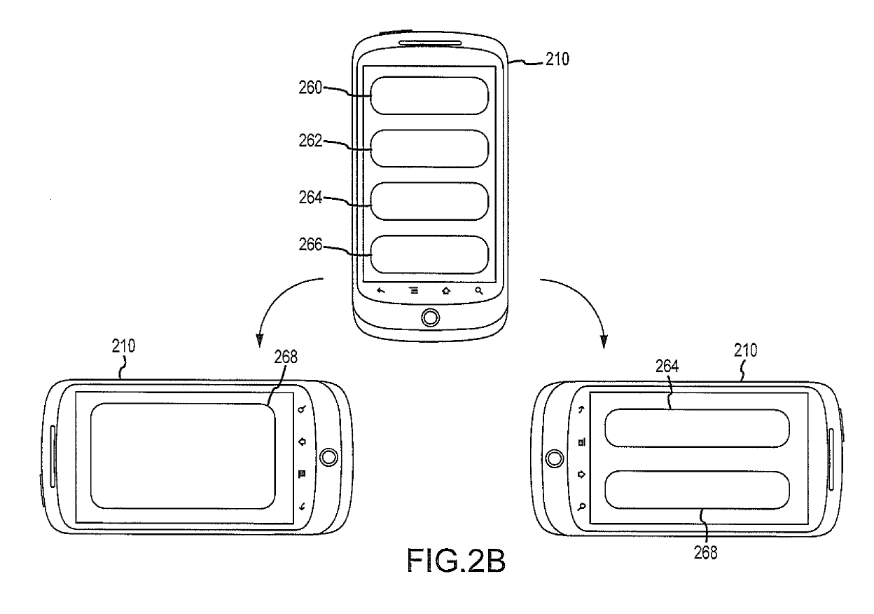

A user of system 100 may detect patient conditions by examining display parameters on remote device 110. The user, however, may be holding several other objects including remote device 110, and it may not be possible to manipulate remote device 110 to view certain display parameters. In certain embodiments of the disclosure, the user may access, examine, and manipulate the display of information regarding a patient on a mobile device using a single hand. Further details regarding how a user may access, examine, and manipulate display parameters are described with reference to FIGS. 2A-6 below.

FIG. 2A illustrates an example remote device 210 of the system 100 for patient monitoring in FIG. 1, according to certain embodiments of the present disclosure. Remote device 210 may be substantially similar to remote device 110 of FIG. 1. In FIG. 2A, remote device 210 is shown as a mobile telephone communicatively coupled with a web server 208 having a web service 226 capability. Web server 208 may be substantially similar to web server 108 of FIG. 1. Remote device 210 includes a storage device 212, a mobile patient monitor 214, a processor 216, a memory 218, a communication interface (I/F) 220, an output device 222, and an input device 224, which are discussed in further detail below. Although this particular implementation of remote device 210 is illustrated and primarily described, the present disclosure contemplates any suitable implementation of remote device 210 according to particular needs.

Storage device 212 may include any suitable device operable for storing data and instructions. Storage device 212 may include, for example, a magnetic disk, flash memory, optical disk, or other suitable data storage device.

Mobile patient monitor 214 may include any suitable logic embodied in computer-readable media, and when executed, that is operable to enable a user to communicate with web service 226 on web server 208 to view and manipulate data, including display parameters. For example, mobile patient monitor 214 may include logic for receiving data from input device 224 and translating the data into a message to be sent to web service 226 on web server 208, in turn enabling a user to activate a browser and navigate a web page generated by web service 226 on web server 208 to view display parameters. The browser may provide, as part of the display parameters, a summary of all medical devices 102 associated with patients under a caregiver's responsibility, or a detailed view that displays specific medical device 102 configuration data, therapy parameter data, and alarm status data. Mobile patient monitor 214 may be configured to cause remote device 210 to periodically request the most recent webpage data from web service 226 on web server 208.

For example, when mobile patient monitor 214 requests a parameter (for example, by clicking a navigation link embedded in a display parameter), the browser transmits the request to web service 226. In embodiments with a browser, web service 226 may extract the request and transmit a copy of the requested parameter in a display parameter format suitable for display by the browser, as well as any required formatting code, such as HTML code, for example. In certain embodiments, formatting code may not be present, such as, for example, in embodiments with a native application at the remote device. Examples of the browser may include a thick client such as an application, or a thin client browser such as Mozilla (Firefox), Netscape, Internet Explorer, or any future browsers.

Processor 216 may include any suitable device operable to execute instructions and manipulate data to perform operations for mobile patient monitor 214. Processor 216 may include, for example, any type of central processing unit (CPU).

Memory 218 may include any computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server). Memory 218 may comprise any other computer-readable tangible medium, or a combination of any of the preceding.

I/F 220 may include any suitable device operable to receive input for mobile patient monitor 214, send output from mobile patient monitor 214, perform suitable processing of the input or output or both, communicate to other devices, or any combination of the preceding. I/F 220 may include appropriate hardware (for example, a modem, network interface card, etc.) and software, including protocol conversion and data processing capabilities, to communicate through a LAN, WAN, or other communication system that allows mobile patient monitor 214 to communicate to other devices. I/F 220 may include one or more ports, conversion software, or a combination of any of the preceding.

Output device 222 may include any suitable device operable for displaying information to a user. Output device 222 may include, for example, a touch screen, a video display, a printer, a plotter, or other suitable output device.

Input device 224 may include any suitable device operable to input, select, and/or manipulate various data and information. Input device 224 may include, for example, a touch screen, a keyboard, mouse, graphics tablet, joystick, light pen, microphone, scanner, or other suitable input device.

Modifications, additions, or omissions may be made to remote device 210 without departing from the scope of the disclosure. The components of remote device 210 may be integrated or separated. Moreover, the operations of remote device 210 may be performed by more, fewer, or other components. For example, although mobile patient monitor 214 is displayed as part of storage device 212, mobile patient monitor 214 may be stored in any suitable location and the operations of mobile patient monitor 214 may be performed by more than one component. Additionally, operations of remote device 210 may be performed using any suitable logic. As used in this document, “each” refers to each member of a set or each member of a subset of a set. Further details of an example remote device 210 are provided below with reference to FIG. 2B.

FIG. 2B illustrates one embodiment of remote device 210 configured to provide certain views of display parameters, according to certain embodiments of the present disclosure. In a first position, perhaps a home position, remote device 210 is configured to display a first set of display parameters, in a first orientation. The first set of display parameters may include display parameter 260, display parameter 262, display parameter 264, and display parameter 266, up to as many display parameters as are desired in the first set of display parameters. In certain embodiments, the first set of display parameters may be scrollable. In certain embodiments, the first set of display parameters may have menu drop-down capabilities. Some or all display parameters within the first set of display parameters may be scrollable and/or zoomable. Remote device 210 may be configured to zoom using any suitable technique such as icons that zoom in and out of a display and/or well-known gestures that zoom into a display.

Upon rotation in a first direction, shown as clockwise in FIG. 2B, to a second position, remote device 210 is configured to display a second set of display parameters. The second set of display parameters may include one or more display parameters selected from the first set of display parameters, as well as different display parameters. In the embodiment shown in FIG. 2B, parameter 264 has been selected for display with parameter 268 upon rotation in a clockwise direction to a second position, in a second orientation. In certain embodiments, the second set of display parameters may have menu drop-down capabilities. Some or all display parameters within the second set of display parameters may be scrollable and/or zoomable.

Upon rotation in a second direction, shown as counter-clockwise in FIG. 2B, to a third position, remote device 210 is configured to display a third set of display parameters that is not identical to the second set of display parameters. In the embodiment shown, the third set of display parameters includes parameter 268 from the second set of display parameters, in a third orientation. In certain embodiments, the third set of display parameters may have menu drop-down capabilities. Some or all display parameters within the third set of display parameters may be scrollable and/or zoomable.

In certain embodiments, remote device 210 is configured such that the second set of display parameters is displayed in response to a user clicking on one of the first set of display parameters and then turning remote device 210 in a first direction. For example, a user may click on display parameter 264, and, upon rotation clockwise, remote device 210 may show display parameter 264 along with display parameter 268. Display parameter 268 may be associated with display parameter 264. Remote device 210 is configured in certain embodiments to display a more detailed view or sub-parameter of a display parameter associated with one of the first set of display parameters. For example, a user may click on parameter 264, and, instead of rotating clockwise, may rotate counter-clockwise for a detailed view of display parameter 268 associated with display parameter 264. Display parameter 268 may be scrollable and/or zoomable when remote device 210 is in the second position or third position.

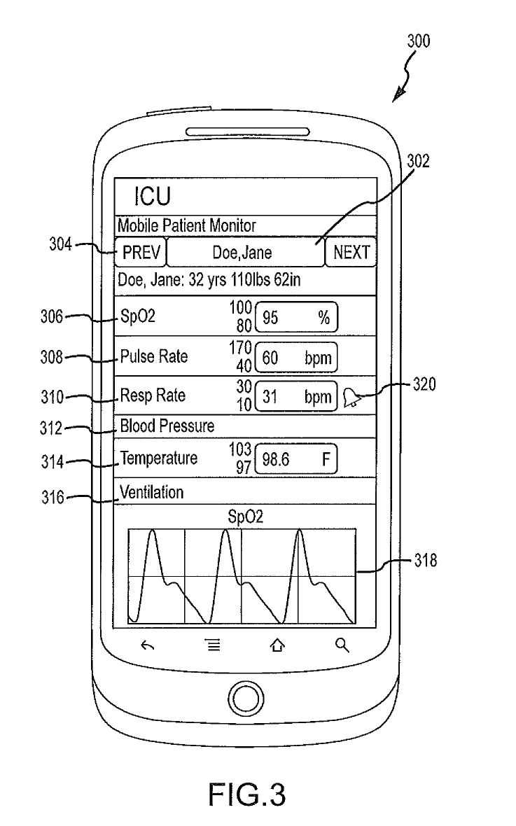

In certain embodiments, remote device 210 is configured such that the second set of display parameters is displayed in response to a user simply turning remote device 210 in a first direction. For example, remote device 210 may be configured such that a top display parameter, here display parameter 260, is displayed along with other display parameters that might be associated with display parameter 260 when a user turns remote device 210 in a first direction. Similarly, remote device 210 may be configured to display a detailed display parameter associated with the top display parameter, here parameter 260, when a user turns remote device 210 in a second direction, without requiring a user to click on display parameter 260 prior to turning remote device 210. Additional details of example embodiments of the present disclosure are provided below with reference to FIGS. 3-6 below.

FIG. 3 illustrates an example remote device 300 of the system 100 for patient monitoring in FIG. 1, according to certain embodiments of the present disclosure. Remote device 300 may be substantially similar to remote device 110 of FIG. 1 and remote device 210 of FIGS. 2A and 2B. In FIG. 3, remote device 300 is shown in a first position, with a first set of display parameters being displayed. The display parameters are derived from one or more medical devices 102. In this embodiment, the first set of display parameters includes a patient identifier 302, an oxygen saturation level 306, a pulse rate 308, respiration rate 310, blood pressure 312, temperature 314, ventilation 316, chart 318, and alarm status 320, threshold values, units of measurement, and placeholders where appropriate. The display parameters further include a pager 304.

In certain embodiments, patient identifier 302 may include a patient name and any appropriate patient notes, such as age, weight, height, and other appropriate information that a user might desire be readily accessible. Patient identifier 302 may also be a number or any other identifier to ensure patient privacy.

Oxygen saturation level 306 is shown with values indicating upper and lower thresholds, 100 and 80, respectively, as well as a current value, 95, and unit of measurement, percentage. Because the value of 95 is within the upper and lower thresholds, no alarm status 320 is shown. Similarly, pulse rate 308 and temperature 314 are shown with upper/lower thresholds, current values, and units of measurement without alarm status 320. In contrast, respiration rate 310 is shown with alarm status 320, because the value of 31 is not within the upper and lower thresholds of 30 and 10 respectively. In certain embodiments, thresholds may be set by medical devices 102; in other embodiments, thresholds may be set by the user of remote device 300. It will be understood that certain parameters may have a single threshold, such as an upper threshold or lower threshold, instead of a range. For example, many measurements related to bacterial infection may have an upper threshold of bacterial count per a given volume without a lower threshold. It will also be understood that alarm status 320 may be indicated in any manner reasonable, such as a change in color or an audio indicator. Alarm status 320 may be included for patients not currently in view, and, in certain embodiments, remote device 300 may be configured to page to an alarming patient automatically when alarm status 320 for that patient is triggered.

In certain embodiments, remote device 300 may be configured to request a certain set of first display parameters, regardless of which display parameters are available, and display placeholders where no display parameters are provided. For example, blood pressure 312 and ventilation 316 are shown without threshold values or other data, indicating in certain embodiments that values for these display parameters have not been provided. In other embodiments, remote device 300 is configured to request and/or receive only those display parameters for which values are available.

As shown in FIG. 3, chart 318 related to oxygen saturation levels may be one of the display parameters. Where appropriate, chart 318 may be scrollable and/or zoomable without interfering with the display of other display parameters, such as pulse rate 308 or patient identifier 302. In certain embodiments, chart 318 is derived from the top display parameter related to a physiological condition and displayed automatically. Chart 318 may include any data displayed in the form of a table, graph, or diagram and may include, for example, trend data, waveform data, and/or plethysmograph display data. In FIG. 3, oxygen saturation 306 is the top display parameter that relates to a physiological condition, as opposed to a patient identifier or other type of display parameter; thus, chart 318 shows display parameters related to oxygen saturation. In certain embodiments, chart 318 may be derived from a display parameter having an alarm status 320. That is, chart 318 may automatically show display parameters relating to, for example, respiration rate 310 in the case of a patient having physiological conditions like that shown in FIG. 3.

In some embodiments, a user may scroll through chart 318 in a vertical or horizontal scroll mode. In certain other embodiments, a user may scroll through chart 318 and cause chart 318 to show display parameters related to other physiological conditions for the patient shown, such as temperature 314, to obtain a history for those display parameters. In some embodiments, a user may scroll through chart 318 related only to a display parameter that has been selected. For example, a user may click or select respiration rate 310 and scroll through a chart 318 related only to respiration rate 310. In some embodiments, a user may scroll through chart 318 related only to a display parameter that is the top display parameter related to a physiological condition.

In certain embodiments, historical data may be viewed by selecting a display parameter for the historical data, such as a click-down menu button or other appropriate selector. For example, where a current value is not available, such as the case of blood pressure 312 in FIG. 3, a user may view historical data related to blood pressure by selecting a separate display parameter dedicated to historical data, or, in certain embodiments, by selected the display parameter itself, here blood pressure 312.

In certain embodiments, a user may scroll through display parameters related to physiological conditions for a single patient, thus changing the top display parameter related to a physiological condition. For example, in the embodiment shown in FIG. 3, a user may swipe up, to cause pulse rate 308 to become the top display parameter related to a physiological condition, while another display parameter, if available, might appear above chart 318; simultaneously, chart 318 may then relate to pulse rate 308, instead of oxygen saturation level 306. If another display parameter is not available, oxygen saturation level 306 might become the bottom display parameter related to a physiological condition, above chart 318.

In some embodiments, a user may select pagers 304 to move between patients associated with a particular user. For example, a user of remote device 300 may be limited to viewing patients located in the intensive care unit (ICU) of a hospital. In other embodiments, a user may swipe patient identifier 302 to move between patients associated with a particular user or department, such as ICU. In certain embodiments, a user may select pagers 304 to move between patients associated with other users, or, to move between patients associated with different departments, for example, moving from patients in ICU to patients in Pediatrics. In certain embodiments, movement between patients may be limited or expanded as desired for a particular user, in any manner appropriate.

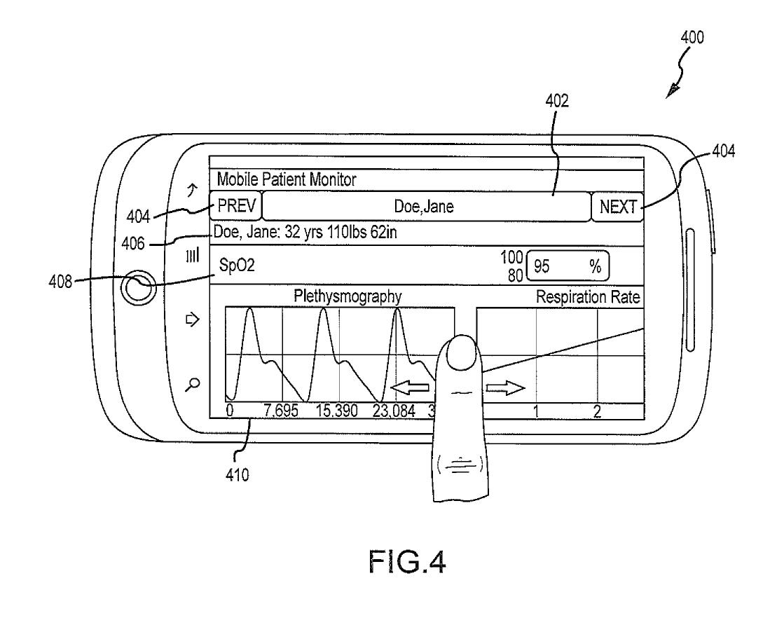

FIG. 4 illustrates an example remote device 400 of the system 100 for patient monitoring in FIG. 1, according to certain embodiments of the present disclosure. Remote device 400 may be substantially similar to remote device 110 of FIG. 1 and remote device 210 of FIGS. 2A and 2B. In FIG. 4, remote device 400 is shown in a second position, with a second set of display parameters being displayed. The display parameters are derived from one or more medical devices 102. In FIG. 4, remote device 400 has been turned in a first direction, and a second set of display parameters are shown in response to the rotation, or, in certain embodiments, the rotation in combination with a user selection. Remote device 400 display parameters include a patient identifier 402, pagers 404, patient notes 406, oxygen saturation level 408, and chart 410. In certain embodiments, the second set of display parameters may have menu drop-down capabilities.

Patient identifier 402 may be shown with patient notes 406 to give a clinician a quick overview of the patient being monitored. Patient notes 406 may include name, age, weight, height, last medical procedure performed, department, patient complaint, or any other suitable information.

Pagers 404 may be selected by a user to move between patients. For example, pager 404 may be selected to cause display parameters related to a different patient to be displayed. In certain embodiments, pagers 404 may be selected to move between display parameters related to a single patient. For example, pager 404 may be selected to cause ventilation to show, instead of display parameter oxygen saturation level 408.

In certain embodiments, remote device 400 may be configured such that chart 410 initially relates to the top display parameter associated with a physiological condition prior to rotation. For example, chart 410 may initially be a plethysmograph where, as shown in FIG. 3, oxygen saturation level 306 is the top display parameter related to a physiological condition. In certain embodiments, chart 410 may initially relate to a display parameter selected by a user prior to rotation. For example, chart 410 may initially be a respiration rate graph where a user has selected temperature 314, shown in FIG. 3, prior to turning remote device 400 to a second position shown in FIG. 4.

In certain embodiments, chart 410 may initially relate to a display parameter having an alarm status. For example, chart 410 may be a respiration rate graph where respiration rate 310 has an alarm status 320, as shown in FIG. 3. Chart 410 may alternatively be related to a display parameter for an alarming patient not in the user's view prior to turning remote device 400.

Chart 410 may be scrollable horizontally as shown in FIG. 4, to allow a user to access display parameters associated with different physiological conditions, thus enabling a clinician to, for example, compare respiration rate with oxygen saturation level 408. In certain embodiments, chart 410 may be scrollable horizontally while remaining with a particular physiological condition, while a vertical scroll feature may allow a user to jump between physiological conditions. When a user scrolls, either horizontally or vertically, to another physiological condition, remote device 400 may be configured such that the top display parameter related to a physiological condition may remain the same, such as oxygen saturation level 408, to allow a user to compare a patient's oxygen saturation level with a heart rate, for example. In certain embodiments, remote device 400 may be configured such that the top display parameter automatically displays a display parameter related to the physiological condition shown in chart 410. In certain embodiments, remote device 400 may be configured such that an alarming patient, along with the most recent alarm status 320 for that patient may automatically be displayed.

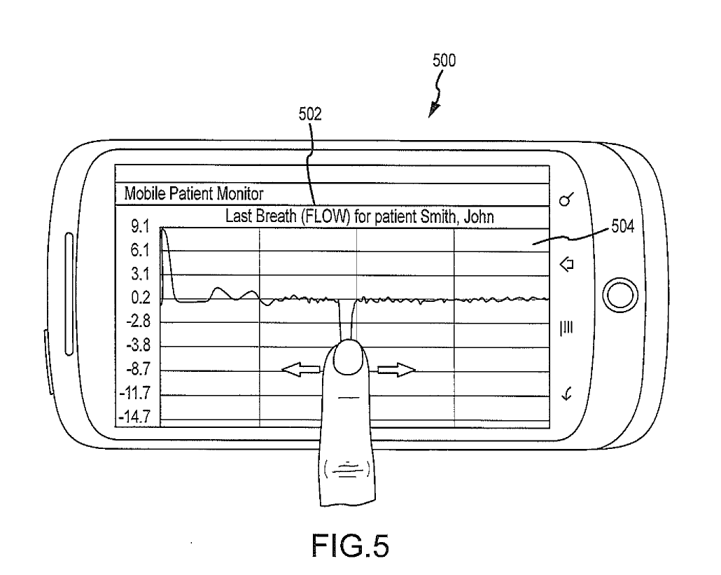

FIG. 5 illustrates an example remote device 500 of the system 100 for patient monitoring in FIG. 1, according to certain embodiments of the present disclosure. Remote device 500 may be substantially similar to remote device 110 of FIG. 1 and remote device 210 of FIGS. 2A and 2B. In FIG. 5, remote device 500 is shown in a third position, with a third set of display parameters being displayed. The display parameters are derived from one or more medical devices 102. In FIG. 5, remote device 500 has been turned in a second direction, and a third set of display parameters are shown in response to the rotation, or, in certain embodiments, the rotation in combination with a user selection. Remote device 500 display parameters include a patient identifier 502, and a chart 504. Chart 504 is related to last breath flow, indicating in certain embodiments that ventilation was the top display parameter related to a physiological condition prior to rotating remote device 500 in a second direction. In certain embodiments, chart 504 may indicate that a user has selected ventilation from the display parameters prior to turning remote device 500 in a second direction. In certain embodiments, remote device 500 may be configured such that an alarming patient, along with the most recent alarm status 320 for that patient may automatically be displayed. In certain embodiments, chart 504 may be scrollable horizontally as shown in FIG. 5, to allow a user to access display parameters associated with different physiological conditions. In certain embodiments, chart 504 may be scrollable horizontally while remaining with a particular physiological condition, while a vertical scroll feature may allow a user to move between physiological conditions.

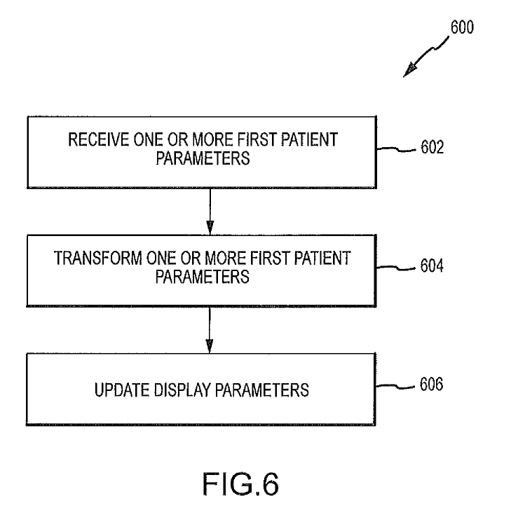

FIG. 6 illustrates an example method 600 for patient monitoring, according to certain embodiments of the present disclosure. Method 600 begins at step 602 where one or more first patient parameters are received from at least one machine. The machine may be substantially similar to medical device 102 in system 100, and the step of receiving may be achieved via wireless or wireline communication with the machine.

At step 604, one or more first patient parameters are transformed into one or more display parameters comprising at least one of a patient identifier, a patient status, and an alarm condition. The display parameters are created such that a first set of the one or more display parameters is operable to be displayed on a device. A second set of the one or more display parameters is operable to be displayed on the device in response to a rotation of the device in a first direction from a first position to a second position, and a third set of the one or more display parameters is operable to be displayed on the device in response to a rotation of the device in a second direction from the first position to a third position. The second set of the one or more display parameters is not identical to the third set of the one or more display parameters.

At step 606, the one or more display parameters are updated in response to receiving one or more second patient parameters. First patient parameters may refer to parameters from a first patient, and second patient parameters may refer to parameters from a second patient. However, first patient parameters may refer to the initial patient parameters, while second patient parameters may refer to parameters from the same patient that have been added or changed. For example, a first patient parameter may be a blood pressure reading from a first patient, while a second patient parameter may be a new blood pressure reading from the same patient; alternatively, or additionally, the second patient parameter may be a blood pressure reading from a second patient. That is, method 600 may comprise receiving one or more second patient parameters from a second machine, and the second machine may be associated with a first patient, a second patient, or multiple patients. In some embodiments, the one or more display parameters may be transmitted to a user interface, such as, for example, remote device 110 in system 100.

In some embodiments, the display parameters may be updated such that both a first patient parameter and a second patient parameter are operable to be displayed in a trending format. FIG. 3 illustrates one example of a trending format.

The one or more display parameters may comprise at least one value indicating a physiological condition and at least one of an acceptable threshold related to the value indicating a physiological condition, a unit of measurement related to the value indicating a physiological condition, and an alarm state related to the value indicating a physiological condition. For example, as shown in FIG. 3, the display parameters may include a pulse rate, as well as a desired maximum and minimum pulse rate, units of bpm, and/or alarm status.

In some embodiments, the first set of the one or more display parameters is operable to be manipulated by a user while the device is in the first position, the second set of the one or more display parameters is operable to be manipulated by a user while the device is in the second position, and the third set of the one or more display parameters is operable to be manipulated by a user while the device is in the third position. FIGS. 1-5 and the associated portions of the description above include examples of how the first, second, and third sets of display parameters may be manipulated by a user in certain embodiments.

Certain embodiments of the present disclosure comprise logic for patient monitoring, such as mobile patient monitor 214 of FIG. 2A, and may be embodied in at least one tangible, computer-readable medium. For example, when the logic is executed, it may be operable to receive one or more first patient parameters from at least one machine, transform the first patient parameters into one or more display parameters, and update the display parameters in response to receiving one or more second patient parameters. The display parameters may comprise at least one of a patient identifier, a patient status, and an alarm condition, such that a first set of the display parameters is operable to be displayed on a device, a second set of the display parameters is operable to be displayed on the device in response to a rotation of the device in a first direction from a first position to a second position, and a third set of the display parameters is operable to be displayed on the device in response to a rotation of the device in a second direction from the first position to a third position. The second set of the one or more display parameters may not be identical to the third set of the one or more display parameters.

In certain embodiments, the logic for patient monitoring may be embodied in more than one tangible, computer-readable medium. For example, portions of the logic for patient monitoring may be embodied in one or more of data collection server 104, application server 106, web server 108, and remote device 110 of system 100 in any manner.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising the steps of:
receiving one or more first patient parameters from at least one machine;
transforming the one or more first patient parameters into one or more display parameters comprising at least one of a patient identifier, a patient status, and an alarm condition, such that a first set of the one or more display parameters is operable to be displayed on a device, a second set of the one or more display parameters is operable to be displayed on the device in response to a rotation of the device in a first direction from a first position to a second position, and a third set of the one or more display parameters is operable to be displayed on the device in response to a rotation of the device in a second direction from the first position to a third position, wherein the second set of the one or more display parameters is not identical to the third set of the one or more display parameters; and
updating the one or more display parameters in response to receiving one or more second patient parameters.

2. The method of claim 1, further comprising receiving one or more second patient parameters from a second machine.

3. The method of claim 1, wherein the one or more display parameters comprise:
at least one value indicating a physiological condition; and
at least one of an acceptable threshold related to the value indicating a physiological condition, a unit of measurement related to the value indicating a physiological condition, and an alarm state related to the value indicating a physiological condition.

4. The method of claim 1, wherein the first set of the one or more display parameters is operable to be manipulated by a user while the device is in the first position, the second set of the one or more display parameters is operable to be manipulated by a user while the device is in the second position, and the third set of the one or more display parameters is operable to be manipulated by a user while the device is in the third position.

5. The method of claim 1, wherein the one or more first patient parameters and the one or more second patient parameters are received via wireless communication.

6. The method of claim 1, further comprising the step of updating the one or more display parameters in response to receiving one or more second patient parameters such that both a first patient parameter and a second patient parameter are operable to be displayed in a trending format.

7. The method of claim 1, further comprising the step of transmitting the one or more display parameters to a user interface.

8. The method of claim 1, wherein at least one of the one or more display parameters is operable to be scrollable or zoomable in response to a user gesture.

9. A system, comprising one or more processing units operable to:
receive one or more first patient parameters from at least one machine;
transform the one or more first patient parameters into one or more display parameters comprising at least one of a patient identifier, a patient status, and an alarm condition, such that a first set of the one or more display parameters is operable to be displayed on a device, a second set of the one or more display parameters is operable to be displayed on the device in response to a rotation of the device in a first direction from a first position to a second position, and a third set of the one or more display parameters is operable to be displayed on the device in response to a rotation of the device in a second direction from the first position to a third position, wherein the second set of the one or more display parameters is not identical to the third set of the one or more display parameters; and
update the one or more display parameters in response to receiving one or more second patient parameters.

10. The system of claim 9, wherein the one or more processing units are operable to receive one or more second patient parameters from a second machine,

11. The system of claim 9, wherein the one or more display parameters comprise:
at least one value indicating a physiological condition; and
at least one of an acceptable threshold related to the value indicating a physiological condition, a unit of measurement related to the value indicating a physiological condition, and an alarm state related to the value indicating a physiological condition.

12. The system of claim 9, wherein the first set of the one or more display parameters is operable to be manipulated by a user while the device is in the first position, the second set of the one or more display parameters is operable to be manipulated by a user while the device is in the second position, and the third set of the one or more display parameters is operable to be manipulated by a user while the device is in the third position,

13. The system of claim 9, wherein the one or more processing units are operable to receive the one or more first patient parameters and the one or more second patient parameters via wireless communication.

14. The system of claim 9, wherein the one or more processing units are operable to update the one or more display parameters in response to receiving one or more second patient parameters such that both a first patient parameter and a second patient parameter are operable to be displayed in a trending format.

15. The system of claim 9, wherein the one or more processing units are operable to transmit the one or more display parameters to a user interface.

16. The system of claim 9, wherein at least one of the one or more display parameters is operable to be scrollable or zoomable in response to a user gesture.

17. Logic embodied in at least one tangible, computer-readable medium and when executed operable to:
receive one or more first patient parameters from at least one machine;
transform the one or more first patient parameters into one or more display parameters comprising at least one of a patient identifier, a patient status, and an alarm condition, such that a first set of the one or more display parameters is operable to be displayed on a device, a second set of the one or more display parameters is operable to be displayed on the device in response to a rotation of the device in a first direction from a first position to a second position, and a third set of the one or more display parameters is operable to be displayed on the device in response to a rotation of the device in a second direction from the first position to a third position, wherein the second set of the one or more display parameters is not identical to the third set of the one or more display parameters; and
update the one or more display parameters in response to receiving one or more second patient parameters.

18. The logic of claim 17, when executed operable to receive one or more second patient parameters from a second machine.

19. The logic of claim 17, wherein the one or more display parameters comprise:
at least one value indicating a physiological condition; and
at least one of an acceptable threshold related to the value indicating a physiological condition, a unit of measurement related to the value indicating a physiological condition, and an alarm state related to the value indicating a physiological condition.

20. The logic of claim 17, wherein the first set of the one or more display parameters is operable to be manipulated by a user while the device is in the first position, the second set of the one or more display parameters is operable to be manipulated by a user while the device is in the second position, and the third set of the one or more display parameters is operable to be manipulated by a user while the device is in the third position.

21. The logic of claim 17, when executed operable to update the one or more display parameters in response to receiving one or more second patient parameters such that both a first patient parameter and a second patient parameter are operable to be displayed in a trending format.

22. The logic of claim 17, when executed operable to transmit the one or more display parameters to a user interface.

23. The logic of claim 17, wherein at least one of the one or more display parameters is operable to be scrollable or zoomable in response to a user gesture.
